(19) United States
(12) Patent Application Publication
(10) Pub. No.: US 2001/0037605 A1
(43) Pub. Date: Nov. 8, 2001

(54) Sliding panel system having panels sliding along at least one slide rail arrangement and movable partition system having a rail, and a rail for a carriage for a movable partition, and a method for use of a movable partition system having a rail, and a partition wall system having a drive mechanism, and a housing, in particular for drive systems of automatic and horizontally movable elements

(76) Inventor: Andreas Finke, Gevelsberg (DE)

Correspondence Address: NILS H. LJUNGMAN, ESQUIRE, NILS H. LJUNGMAN & ASSOCIATES, P.O. BOX 130, GREENSBURG, PA, 15601-0130, US

(21) Appl. No.: 09/745,069

(22) Filed: Dec. 20, 2000

(30) Foreign Application Priority Data
Dec. 21, 1999 (DE) 199 62 074.1

(51) Int. Cl. E05D 15/00; E05F 11/00

(52) U.S. Cl. 49/360; 16/87 R; 49/409

(57) ABSTRACT

A sliding panel system having panels sliding along at least one slide rail arrangement and movable partition system having a rail, and a rail for a carriage for a movable partition, and a method for use of a movable partition system having a rail, and a partition wall system having a drive mechanism, and a housing, in particular for drive systems of automatic and horizontally movable elements. The housing is used in particular to hold mechanical, electrical and electronic components, and has been simplified from the point of view of manufacturing and installation, and the torsional rigidity has been increased. The housing consists of a C-shaped transom profile which can be closed by means of a closing profile to realize a housing interior, and on which a support leg is realized in one piece, thereby forming a cavity.

### BACKGROUND OF THE INVENTION

1. Field of the Invention

The invention relates to a sliding panel system having panels sliding along at least one slide rail arrangement and movable partition system having a rail, and a rail for a carriage for a movable partition, and a method for use of a movable partition system having a rail, and a partition wall system having a drive mechanism and a housing, in particular for drive systems of automatic and horizontally movable elements and a housing for automatic drive systems. The housing thereby consists essentially of a transom profile and a closing profile located on it.

2. Background of the Invention

Housings of this type are used, for example, in automatic drive systems for sliding doors of all types or horizontally movable elements. DE 198 04 860 C1 describes a housing that consists of a transom profile and a facing that is to be attached to it. The running devices for the movable elements are located inside the housing along with their suspension devices, as well as the drive units such as the motor, drive wheels and deflector pulleys for a toothed belt or chain. The housing can also contain an open-loop or closed-loop control system for the drive motor, which control system can be activated by corresponding sensor signals.

Attempts to develop the smallest possible housings using lightweight materials have resulted in a worsening of the already unfavorable ratio between the length and the cross section of the housing, and thus have thus necessarily led to extremely unstable designs. The handling and installation of the already complicated sheet metal housing is made even more difficult by these unfavorable parameters.

### OBJECT OF THE INVENTION

The object of the invention is therefore to eliminate the defects of similar devices of the prior art and thereby create a housing that can hold all of the components for automatically movable elements, and one that can be simplified in terms of the manufacturing and installation work required, whereby the torsional stiffness of the housing is also increased.

### SUMMARY OF THE INVENTION

The invention teaches that the object of the invention can be accomplished by the features disclosed as follows: Housing, in particular for automatic drive systems of horizontally movable elements, whereby the housing is used in particular to hold mechanical, electrical and electronic components such as running devices, suspension devices for movable elements, drive units consisting of power transmission means, coupling, motor and displacement sensing devices, auxiliary drives, open-loop/closed-loop control systems, power supply, sensors etc. The dependent claims disclose additional embodiments of the teaching of the invention.

The housing consists essentially of a one-piece C-shaped transom profile and a closing profile which is pivotably fastened to it, whereby the transom profile has a longitudinal leg and transverse or cross legs attached to its ends. Between the longitudinal leg and the lower transverse leg, a support leg is molded on in one piece, forming a cavity. The support leg increases the torsional stiffness of the transom profile and thereby makes the housing significantly easier to handle and install. The transport of the profile is facilitated as early as immediately after the fabrication of the extruded transom profile, because the number and scope of the transport structures can be reduced. During installation, warping that can damage the shape of the housing is effectively eliminated. The support leg is located between the longitudinal leg and the lower transverse leg, because that is where the weight of the movable elements exerts the highest load. The distance of the support leg from the intersection between the longitudinal leg and the lower transverse leg is a parameter that contributes to the increase in stability. To further increase the torsional stiffness, the support leg is realized with a step or steps.

The closing profile is oriented parallel to the longitudinal leg, and is fastened so that it can pivot on the free end of the upper transverse leg. Between the lower portion of the closing profile and the free end of the lower transverse leg, a slot is realized which makes it possible to establish the connection between the devices that are located inside the housing and the movable elements. At various points on the transom profile, there are undercut mounting grooves which are used to fasten the drive units, the running devices or various accessories. On the ends of the transom profile, there are end caps which are installed separately and can be inserted, for example, into the mounting grooves by means of molded-on tabs and then bolted in place. Thus a housing has been created which is hermetically sealed against outside influences. Such housings can be manufactured in the form of extruded light alloy profiles, and can be cut to the desired length appropriate to the drive system.

The housing is fastened by means of the upper transverse leg to a stationary structure using a positive and non-positive connection. For this purpose, the transverse leg is designed so that it provides the appropriate stability. The closing profile is located on the free end of the upper transverse leg, and in particular so that the closing profile is fastened by an interlock so that it can pivot. The interlock is preferably realized on a separate adapter profile which is fastened in a corresponding locking chamber on the free end of the transverse leg. The use of an adapter profile makes it possible to easily adapt the transom profile to local conditions without the need for constructive modifications.

The free end of the lower transverse leg is used to hold a separate running profile or track or track profile, so that it is possible to move the support rollers of the truck of the movable element. The running profile is thereby located on the transverse leg so that it can be removed and replaced as necessary. As a result of this ability to replace the running profile, it is possible to use the appropriate running profile, depending on the type of operation desired, i.e. also depending on the weight of the door panel.

An extension molded onto the support leg has a cross strut which on one hand covers the track rollers, so that no external factors, such as dirt, for example, can interfere with the travel of the track rollers. On the other hand, the cross strut, which utilizes the stepped design of the support leg, forms a channel that is open on one side and in which the electrical lines necessary for the drive system and/or for an open-loop/closed-loop control system can be laid. The channel can be closed by means of a cover, whereby the cover is fastened in an mounting groove that is realized in the cross strut.

Below the lower transverse leg, there is an accessory channel that is open on the bottom and which can be used, for example, to install a bearing for the side piece that must be able to pivot in emergencies. A cover profile is inserted and locked in place as a closing between the accessory channel that consists of two webs. A U-shaped profile can be in contact with an extension of one web, which profile can contain additional accessory devices or equipment such as, for example, a stop to define the maximum deflection of the swinging panel.

In an additional configuration of the housing claimed by the invention, it is possible to install optional or alternate components in or on the housing. Such accessory devices, which can be configured in different ways depending on the individual application, are located so that they can be moved the undercut mounting grooves, and can be secured by corresponding threaded or snap-in elements. These types of attachments have been found to be particularly appropriate, because such mounting grooves are easy to realize during the manufacturing operations, and provide additional stability for the housing. The mounting grooves, which are formed during the extrusion of the profile, also extend over the entire length of the profile, which means that there is extreme flexibility in the positioning of the accessory devices. Conceivable accessory devices include printed circuit boards for the open-loop/closed-loop control systems of the drive system, or additional housing parts such as, for example, covers or partitions between functional areas. A power supply or sensors can also naturally be located inside the housing.

The above-discussed embodiments of the present invention will be described further hereinbelow. When the word “invention” is used in this specification, the word “invention” includes “inventions”, that is the plural of “invention”. By stating “invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below with reference to the exemplary embodiment which is illustrated schematically in the accompanying drawings, in which:

FIG. 1 is a sectional view through a partly equipped housing;

FIG. 1A is another sectional view through a partly equipped housing;

FIG. 2 is a sectional view through an unequipped housing like the one illustrated in FIG. 1;

FIG. 2A is another sectional view through an unequipped housing like the one illustrated in FIG. 1A;

FIG. 3 is a detail of the cover profile illustrated in FIG. 1;

FIG. 4 is a detail of the U-profile illustrated in FIG. 1; and

FIG. 5 is a view of a sliding panel system.

### DESCRIPTION OF THE PREFERRED EMBODIMENTS

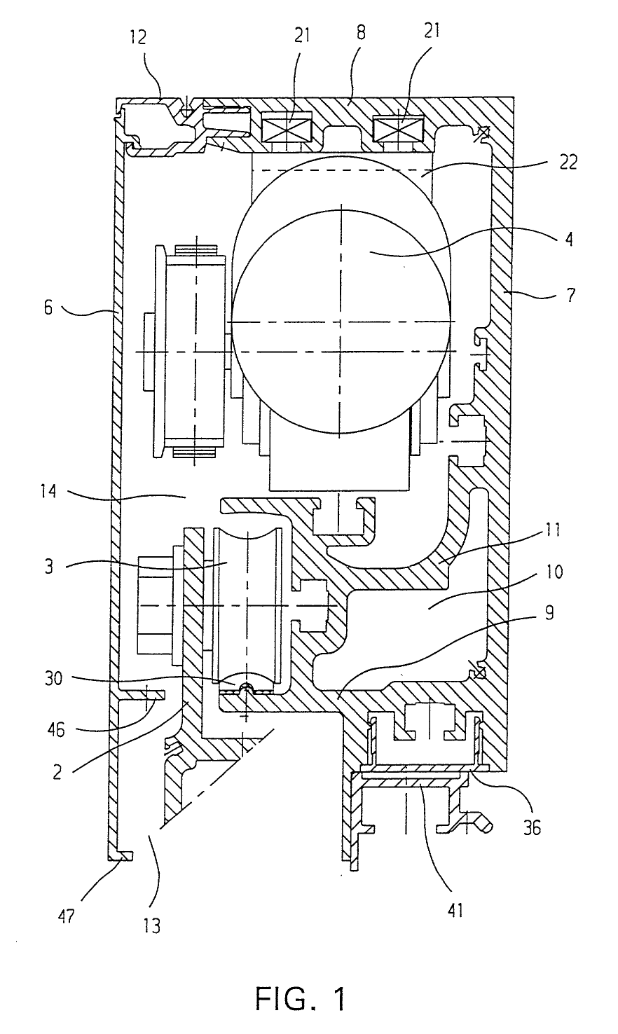

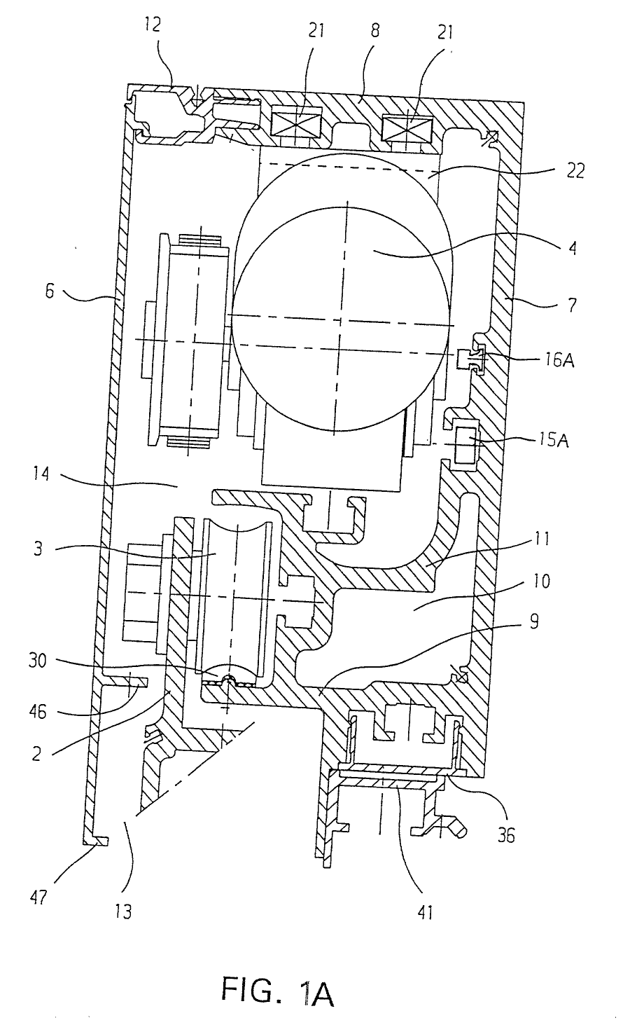

A housing 1, which can be used for a sliding door drive system, for example, whereby individual elements of the door system such as the fixed side pieces and the movable panel are not shown, is illustrated in FIGS. 1 to 4. In this case, the housing 1 is shown in a sectional view at a right angle to the longitudinal direction. In the interest of completeness, it should be noted that such housings 1 can also be used for the drive mechanisms of curved sliding doors, movable partitions and revolving doors, whereby the exemplary embodiment illustrated relates solely and exclusively to the use of the drive mechanism for a sliding door drive system. Inside the housing 1 is a running device for the door panels in the form of a truck 2 with a roller 3 fastened rotationally to it, and a drive unit 4 with a motor, drive wheels and pulleys not illustrated in any further detail for a drive belt or a chain. Inside the housing 1, there is also the open-loop/closed-loop electrical control system (not shown) which is activated by corresponding sensor signals for the drive unit 4.

The housing 1 consists essentially of a C-shaped transom profile 5 and a closing profile 6 fastened pivotably to it, whereby the transom profile has one longitudinal leg 7 and transverse legs 8 and 9 connected at right angles to its ends. The transverse legs 8, 9 are of approximately equal length and are each equal to approximately one-half the length of the longitudinal leg 7. Between the longitudinal leg 7 and the lower transverse leg 9, forming a cavity 10, a support leg 11 is molded in one piece with the rest of the profile. The closing profile 6 is oriented parallel to the longitudinal leg 7 and is fastened by means of an adapter profile 12 to the upper transverse leg 8. Between the closing profile 6 and the lower transverse leg 9, a slot 13 is realized, which makes it possible too connect the running devices 2, 3 that are located in the interior of the housing with the movable elements. At various points on the transom profile 5, there are undercut mounting grooves 15, 16 which are used to fasten the drive unit 4 and various accessories which are not shown in any greater detail. On the ends of the transom profile 5, there are separately installed end caps (not shown), which can be inserted, for example, by means of molded-on tabs into the mounting grooves 15 and then bolted in place. Thus a housing 1 has been created which is hermetically sealed against outside influences. The housing 1 can be manufactured in the form of extruded light alloy profiles, and can be cut to the desired length appropriate to the drive system.

The housing 1 and/or transom profile 5 is fastened by means of the upper transverse leg 8 to a stationary structure, for example a ceiling, a substructure or similar structure, using a positive and non-positive connection. For this purpose, the transverse leg 8 is designed so that it provides the appropriate stability. On its free end, the upper transverse leg 8 has a chamber 17 that is open on one side, in which there is a rib 18 for the locking fastening of the adapter profile 12. Between the chamber 17 and the longitudinal leg 7, there are two mounting grooves 15 that are at some distance from each other in the transverse leg 8, each of which is undercut by facing, hook-like projections 20 that extend into an opening 19. Square-head bolts 21 are located in the two mounting grooves 15 in a positively form-fitting or interlocking manner, to which a mounting bracket 22 of the drive unit 4 is bolted. In the transitional area between the transverse leg 8 and the longitudinal leg 7, on the inside of the housing, there is a circular bolt channel 23, which is used in particular to bolt the end caps in place.

The longitudinal leg 7, approximately halfway between the two transverse legs 8, 9, has two mounting grooves 15, 16 that are located one below the other, the upper mounting groove 16 of which is significantly smaller than all the other mounting grooves 15. On the inside of the housing, in the transitional area between the longitudinal leg 7 and the lower transverse leg 9, there is an additional bolting channel 23. The stepped support leg 11 runs diagonally between the longitudinal leg 7 and the lower transverse leg 9, thereby forming the cavity 10. The support leg 11 is connected flush with the corresponding projection 20 of the mounting groove 15 of the longitudinal leg 7, and makes the transition into a horizontal leg segment 25, forming a shell-shaped channel 24. Electrical lines and devices of the drive system or its control system can be housed in the channel 24. The support leg 11 then makes the transition into a stepped vertical leg segment 26 which is connected to the lower transverse leg 9. The vertical leg segment 26 makes a transition at the interface with the horizontal leg segment 25 into a vertical extension 27 which ends in a cross strut 28 which is extended on both sides. On the right side, the cross strut 28 projects into the channel 24 and represents its lateral wall. In the cross strut 28, there is also an additional mounting groove 15, in which a cover for the channel 24 and/or optional partition elements can be mounted. On the left side, the cross strut 28 runs parallel to the lower transverse leg 9. Between the cross strut 28 and the bottom transverse leg 9, a protected space is thereby created for the travel of the track rollers 3. A rib 29 is realized on the bottom transverse leg 9, so that a running profile can be positively attached there. The running profile 30 is fastened non-positively by means of a clamp (not shown). In the vertical leg segment 26 there is an additional mounting groove 15, in which a limit stop for the horizontal movement of the running device 2, 3 can be mounted.

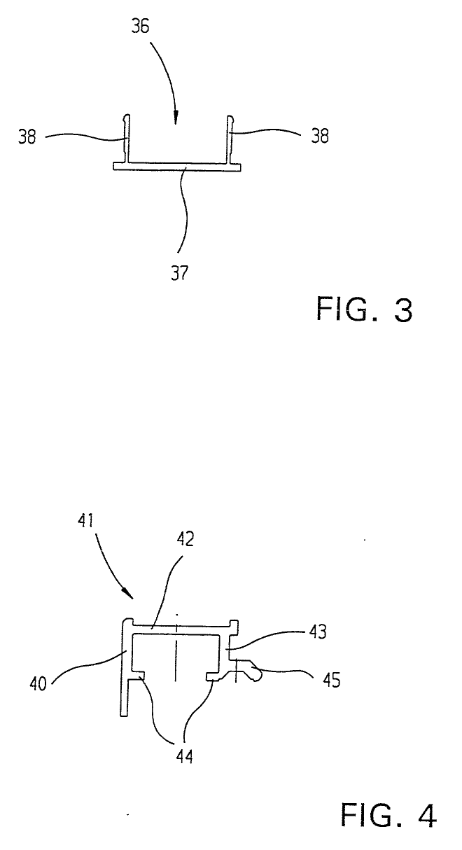

On the underside 31 of the lower transverse leg 9, between two webs 32 and 33, there is an accessory channel 34 that is open on the bottom, for the installation of a bearing for the side piece, which must be able to pivot in emergencies. The bearing is fastened by means of a mounting groove 15 which is realized at this point on the lower transverse leg 9. The web 33 represents a flush elongation of the longitudinal leg 7. On the inside of the webs 32, 33, ribs 35 are formed, onto which a cover profile 36, which is illustrated in greater detail in FIG. 3, can be positively clipped. The cover profile 38 has a cover profile 37, from which elastically flexible locking arms 38 project at right angles.

The web 32 is elongated by means of a tapered extension 39, so that at this point, a leg 40 of a U-shaped profile 41 is in positive or interlocking contact. Adjacent to the leg 40 at a right angle is a transverse partition 42 and adjacent to that, again at a right angle, an additional leg 43. The U-shaped profile 41 is fastened by means of a threaded connection to the lower transverse leg 9. Between the legs 40 and 43, a stop can be installed to limit the maximum deflection of the swinging panel, whereby inwardly directed edges 44 on the legs 40, 43 guarantee an interlocking connection. An overhang or a projection 45 is also realized on the leg 43.

The closing profile 6 forms the front-side panel of the transom profile 5 and is oriented parallel to the longitudinal leg 7 by means of the adapter profile 12 on the upper transverse leg 8. The connection between the adapter profile 12 and the closing profile 6 is realized so that the closing profile 6 can be pivoted, positioned or even removed, if necessary, for installation of maintenance work, even if the housing is installed in or near the ceiling. The closing profile 6 has two transverse webs 46 and 47, to essentially completely prevent the penetration of foreign objects into the housing 1. The transverse web 46 is located at the level of the lower transverse leg 9, while the transverse web 47 closes the closing profile 6 on the underside.

FIG. 1A shows a snap-in element 15A within mounting grooves 15 and a snap-in element 16A within mounting grooves 16.

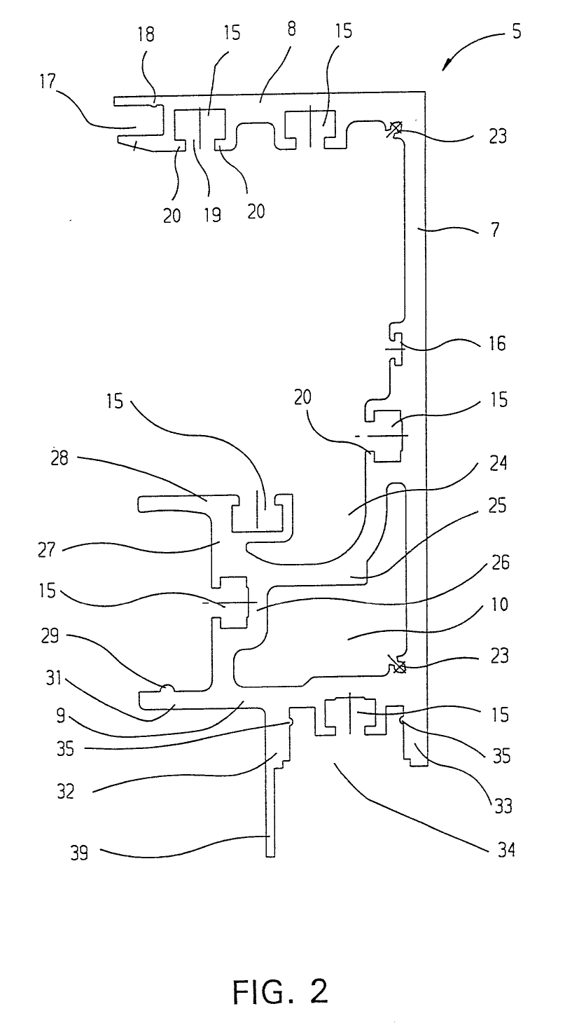

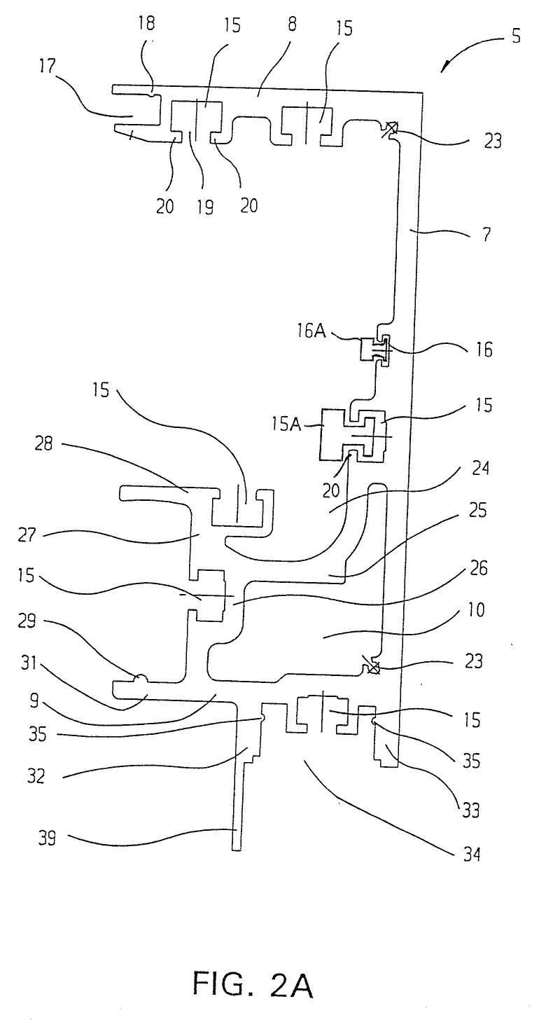

FIG. 2A shows a snap-in element 15A within mounting grooves 15 and a snap-in element 16A within mounting grooves 16.

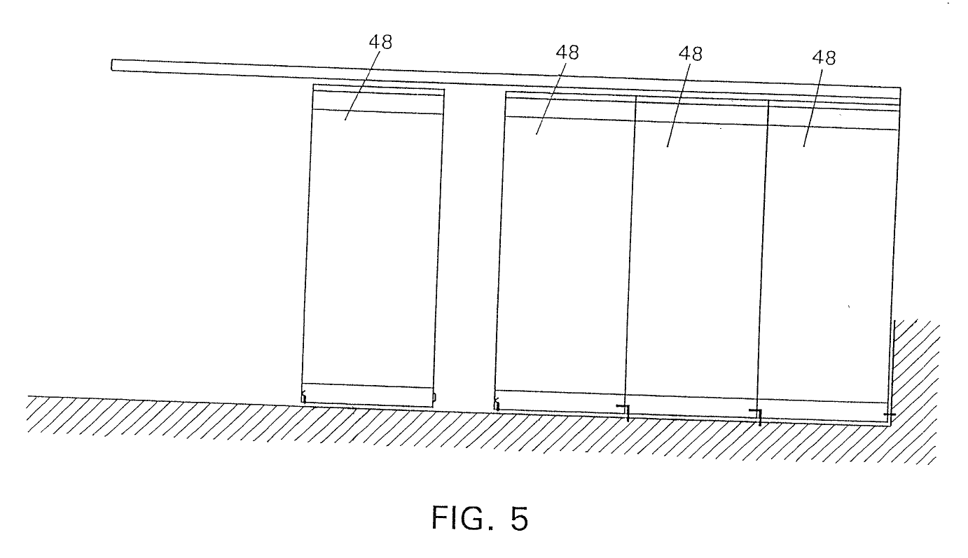

FIG. 5 shows a sliding panel system with panels 48.

One feature of the invention resides broadly in a housing, in particular for automatic drive systems of horizontally movable elements, whereby the housing (1) is used in particular to hold mechanical, electrical and electronic components such as running devices (2, 3), suspension devices for movable elements, drive units (4) consisting of power transmission means, coupling, motor and displacement sensing devices, auxiliary drives, open-loop/closed-loop control systems, power supply, sensors etc., characterized by the fact that the housing (1) consists of a C-shaped transom profile (5) which can be closed by means of a closing profile (6) to realize a housing interior (14) and on which a support leg (11) is realized in one piece, thereby forming a cavity (10).

Another feature of the invention resides broadly in a housing characterized by the fact that the transom profile (5) has a longitudinal leg (7), to which transverse legs (8, 9) are connected at right angles on the upper and lower ends, whereby the support leg (11) is realized between the longitudinal leg (7) and the lower transverse leg (9).

Yet another feature of the invention resides broadly in a housing characterized by the fact that the support leg (11) is stepped and has a horizontal leg segment (25) and a vertical leg segment (26).

Still another feature of the invention resides broadly in a housing characterized by the fact that the support leg (11) forms a closable channel (24).

A further feature of the invention resides broadly in a housing characterized by the fact that shaped onto the support leg (11) is a vertical extension (27) that ends in a cross strut (28) that is extended toward both sides.

Another feature of the invention resides broadly in a housing, characterized by the fact that undercut mounting grooves (15, 16) are realized on the extension (27), the support leg (11), the transverse legs (8, 9) and/or the longitudinal leg (7).

Yet another feature of the invention resides broadly in a housing characterized by the fact that in the upper transverse leg (8), there are two mounting grooves (15) which are at some distance from each other.

Still another feature of the invention resides broadly in a housing characterized by the fact that the closing profile (6) is located on the upper transverse profile (8).

A further feature of the invention resides broadly in a housing characterized by the fact that on the upper transverse leg (8), a chamber (17) is realized for the locking attachment of an adapter profile (12), whereby the closing profile (6) is located on the adapter profile (12).

Another feature of the invention resides broadly in a housing characterized by the fact that a running profile (30) can be positively fastened on the bottom transverse leg (9).

Yet another feature of the invention resides broadly in a housing characterized by the fact that on the underside lower transverse leg (9), between webs (32, 33), there is an accessory channel (34), in which a mounting groove is realized.

Still another feature of the invention resides broadly in a housing characterized by the fact that the accessory channel (34) can be closed positively in an interlocking manner by a cover profile (36), whereby the cover profile (36) consists of a cover (37) and two elastically deflectable locking arms (38) which project at right angles.

A further feature of the invention resides broadly in a housing characterized by the fact that the web (32) has an extension (39), on which a U-shaped profile (41) can be located, which profile can be fastened to the lower transverse leg (9).

Another feature of the invention resides broadly in a housing characterized by the fact that the U-shaped profile (41) consists of a transverse partition (42) and two legs (40, 43) that project from it at right angles, whereby the legs (40, 43) each have inwardly bent edges (44) and the leg (43) has an outside projection (45).

Yet another feature of the invention resides broadly in a housing characterized by the fact that bolt channels (23) are formed between the longitudinal leg (7) and each of the transverse legs (8, 9).

The components disclosed in the various publications, disclosed or incorporated by reference herein, may be used in the embodiments of the present invention, as well as equivalents thereof.

The appended drawings in their entirety, including all dimensions, proportions and/or shapes in at least one embodiment of the invention, are accurate and are hereby included by reference into this specification.

All, or substantially all, of the components and methods of the various embodiments may be used with at least one embodiment or all of the embodiments, if more than one embodiment is described herein.

All of the patents, patent applications and publications recited herein, and in the Declaration attached hereto, are hereby incorporated by reference as if set forth in their entirety herein.

The corresponding foreign patent publication application, namely, Federal Republic of Germany Patent Application No.199 62 074.1, filed on Dec. 21, 1999, having inventor Andreas FINKE, as well as its published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

The details in the patents, patent applications and publications may be considered to be incorporable, at applicant's option, into the claims during prosecution as further limitations in the claims to patentably distinguish any amended claims from any applied prior art.

Some examples of housing or access panels which may be utilized or incorporated in at least one possible embodiment of the present invention may be found in U.S. Pat. No. 5,327,682, issued on Jul. 12, 1994.

Some examples of guide rails or systems for door, wall or partition systems which may be utilized or incorporated in at least one possible embodiment of the present invention may be found in the following U.S. Pat. No. 5,538,064, issued to inventor Salice on Jul. 23, 1996; U.S. Pat. No. 5,327,681, issued to inventor Minami on Jul. 12, 1994; U.S. Pat. No. 4,759,099, issued to inventors Morano et al. on Jul. 26, 1988; U.S. Pat. No. 4,555,828, issued to inventor Matimura on Dec. 3, 1985; and U.S. Pat. No. 4,084,289, issued to inventor Naimo on Apr. 18, 1978.

Some examples of doors, foldable doors, or door systems and mechanisms and devices for their operation which may be utilized or incorporated in at least one possible embodiment of the present invention may be found in the following U.S. Pat. No. 5,762,123, issued to inventors Kuyama et al. on Jun. 9, 1998; U.S. Pat. No. 5,651,216, issued to inventor Tillmann on Jul. 29, 1997; U.S. Pat. No. 5,186,230, issued to inventor Ostrander on Feb. 16, 1993; U.S. Pat. No. 5,165,142, issued to inventor Pilsbury on Nov. 24, 1992; U.S. Pat. No. 5,163,494, issued to inventors MacNeil et al. on Nov. 17, 1992; U.S. Pat. No. 5,099,903, issued to inventor Chen on Mar. 31, 1992; U.S. Pat. No. 5,070,926, issued to inventor Behring on Dec. 10, 1991; and U.S. Pat. No. 4,932,455, issued to inventor Yamada on Jun. 12, 1990.

Some examples of movable partition or wall systems and devices for their operation which may be utilized or incorporated in at least one possible embodiment of the present invention may be found in the following U.S. Pat. No. 5,730,027, issued to inventor Hormann on Mar. 24, 1998; U.S. Pat. No. 5,461,829, issued to inventors Lehto et al. on Oct. 31, 1995; U.S. Pat. No. 5,404,675, issued to inventor Schmidhauser on Apr. 11, 1995; U.S. Pat. No. 5,329,857, issued to inventor Owens on Jul. 19, 1994; U.S. Pat. No. 5,295,281, issued to inventor Kordes on Mar. 22, 1994; U.S. Pat. No. 5,394,648, issued to inventor Kordes on Mar. 7, 1995; U.S. Pat. No. 5,417,013, issued to inventor Tillmann on May 23, 1995; U.S. Pat. No. 5,544,462, issued to inventor Kordes on Aug. 13, 1996; U.S. Pat. No. 5,406,761, issued to inventors Hobbiebrunken et al. on Apr. 18, 1995; U.S. Pat. No. 5,152,332, issued to inventor Siener on Oct. 6, 1992; U.S. Pat. No. 5,042,555, issued to inventor Owens on Aug. 27, 1991; U.S. Pat. No. 4,934,119, issued to inventor Ybarra on Jun. 19, 1990; U.S. Pat. No. 4,914,878, issued to inventors Tamaki et al. on Apr. 10, 1990; U.S. Pat. No. 4,895,246, issued to inventor Rizzi on Jan. 23, 1990; U.S. Pat. No. 4,752,987, issued to inventors Dreyer et al. on Jun. 28, 1988; U.S. Pat. No. 4,596,094, issued to inventors Teller et al. on Jun. 24, 1986; U.S. Pat. No. 4,555,828, issued to inventor Matimura on Dec. 3, 1985; U.S. Pat. No. 4,458,462, issued to inventor Schold on Jul. 10, 1984; U.S. Pat. No. 4,404,770, issued to inventor Markus on Sep. 20, 1983; and U.S. Pat. No. 4,112,647, issued to inventor Scheid on Sep. 12, 1978.

Some examples of drives or electromechanical or electro-hydraulic drives which may be utilized or incorporated in at least one possible embodiment of the present invention may be found in the following U.S. Pat. No. 5,666,268, issued to inventors Rix et al. on Sep. 9, 1997; U.S. Pat. No. 5,386,885, issued to inventors Bunzl et al. on Feb. 7, 1995; U.S. Pat. No. 5,521,400, issued to inventor Schultze on Oct. 12, 1993; U.S. Pat. No. 5,080,635, issued to inventors Martinez et al. on Jan. 14, 1992; U.S. Pat. No. 4,501,090, issued to inventors Yoshida et al. on Feb. 26, 1985; and U.S. Pat. No. 4,430,846, issued to inventors Presley et al. on Feb. 14, 1984.

Some examples of electronic control or electronic regulation systems which may be utilized or incorporated in at least one possible embodiment of the present invention may be found in the following U.S. Pat. No. 5,770,934, issued to inventor Theile on Jun. 23, 1998; U.S. Pat. No. 5,666,268, issued to inventors Rix et al. on Sep. 9, 1997; U.S. Pat. No. 5,625,266, issued to inventor Stark on Apr. 29, 1997; U.S. Pat. No. 5,428,278, issued to inventors Bollengier et al. on Jun. 27, 1995; and U.S. Pat. No. 4,838,052, issued to inventors Williams et al. on Jun. 13, 1989.

Some examples of control systems which measure operating parameters and learn therefrom which may be utilized or incorporated in at least one possible embodiment of the present invention may be found in the following U.S. Pat. No. 5,770,934, issued to inventor Theile on Jun. 23, 1998; U.S. Pat. No. 5,191,272, issued to inventors Torii et al. on Mar. 2, 1993; U.S. Pat. No. 5,223,820, issued to inventors Sutterlin et al. on Jun. 29, 1993; and U.S. Pat. No. 4,655,188, issued to inventors Tomisawa et al. on Apr. 7, 1987.

Some examples of memories which may be utilized or incorporated in at least one possible embodiment of the present invention may be found in the following U.S. Pat. No. 5,789,887, issued to inventor Elischewski on Aug. 4, 1998; U.S. Pat. No. 5,770,934, issued to inventor Theile on Jun. 23, 1998; U.S. Pat. No. 5,453,736, issued to inventor Noren on Sep. 26, 1995; U.S. Pat. No. 5,315,220, issued to inventors Takimoto et al. on May 24, 1994; U.S. Pat. No. 4,994,724, issued to inventor Hsu on Feb. 19, 1991; U.S. Pat. No. 4,498,033, issued to inventors Aihara et al. on Feb. 5, 1985; and U.S. Pat. No. 4,328,540, issued to inventors Matsuoka et al. on May 4, 1982.

Some examples of microprocessors which may be utilized or incorporated in at least one possible embodiment of the present invention may be found in the following U.S. Pat. No. 5,770,934, issued to inventor Theile on Jun. 23, 1998; U.S. Pat. No. 5,653,056, issued to inventor Stark on Aug. 5, 1997; U.S. Pat. No. 5,647,173, issued to inventors Stark et al. on Jul. 15, 1997; U.S. Pat. No. 5,625,266, issued to inventor Stark on Apr. 29, 1997; U.S. Pat. No. 5,479,151, issued to inventors Lavelle et al. on Dec. 26, 1995; U.S. Pat. No. 5,453,736, issued to inventor Noren on Sep. 26, 1995; U.S. Pat. No. 5,437,174, issued to inventor Aydin on Aug. 1, 1995; U.S. Pat. No. 5,274,312, issued to inventor Gerstenkorn on Dec. 28, 1993; U.S. Pat. No. 5,230,179, issued to inventors Richmond et al. on Jul. 27, 1993; U.S. Pat. No. 5,142,152, issued to inventor Boiucaner on Aug. 25, 1992; U.S. Pat. No. 5,140,173, issued to inventors Chau et al. on Aug. 18, 1992; U.S. Pat. No. 5,136,809, issued to inventors Richmond et al. on Aug. 11, 1992; U.S. Pat. No. 5,132,503, issued to inventor Lee on Jul. 21, 1992; U.S. Pat. No. 4,980,618, issued to inventors Milnes et al. on Dec. 25, 1990; U.S. Pat. No. 4,831,509, issued to inventors Jones et al. on May 16, 1989; U.S. Pat. No. 4,815,046, issued to inventor Dorr on Mar. 21, 1989; and U.S. Pat. No. 4,779,240, issued to inventor Dorr on Oct. 18, 1988.

Some examples of open-loop control systems which may be utilized or incorporated in at least one possible embodiment of the present invention may be found in the following U.S. Pat. No. 5,770,934, issued to inventor Theile on Jun. 23, 1998; U.S. Pat. No. 5,210,473, issued to inventor Backstrand on May 11, 1993; U.S. Pat. No. 5,320,186, issued to inventors Strosser et al. on Jun. 14, 1994; and U.S. Pat. No. 5,369,342, issued to inventors Rudzewicz et al. on Nov. 29, 1994.

Some examples of closed-loop control circuits which may be utilized or incorporated in at least one possible embodiment of the present invention may be found in the following U.S. Pat. No. 5,770,934, issued to inventor Theile on Jun. 23, 1998; U.S. Pat. No. 5,189,605, issued to inventors Zuehlke et al. on Feb. 23, 1993; U.S. Pat. No. 5,223,072, issued to inventors Brockman et al. on Jun. 29, 1993; and U.S. Pat. No. 5,252,901, issued to inventors Ozawa et al. on Oct. 12, 1993.

Some examples of look up tables accessed by computers or microprocessors which may be utilized or incorporated in at least one possible embodiment of the present invention may be found in the following U.S. Pat. No. 5,284,116, issued to inventor Richeson, Jr. on Feb. 8, 1994; U.S. Pat. No. 5,359,325, issued to inventors Ford et al. on Oct. 25, 1994; and U.S. Pat. No. 5,371,537, issued to inventors Bohan et al. on Dec. 6, 1994.

Some examples of databuses or databus systems which may be utilized or incorporated in at least one possible embodiment of the present invention may be found in the following U.S. Pat. No. 6,008,546, issued to inventor Sage on Dec. 28, 1999; U.S. Pat. No. 5,978,193, issued to inventor Kaaden on Nov. 2, 1999; U.S. Pat. No. 5,815,732, issued to inventors Cooper et al. on Sep. 29, 1998; U.S. Pat. No. 5,507,001, issued to inventor Nishizawa on Apr. 9, 1996; U.S. Pat. No. 5,402,423, issued to inventors Van Kersen on Mar. 28, 1995; U.S. Pat. No. 4,725,838, issued to inventors Maschek et al. on Feb. 16, 1998; U.S. Pat. No. 4,720,155, issued to inventors Schildkraut et al. on Jan. 19, 1988; and U.S. Pat. No. 4,488,066, issued to inventor Shoji on Dec. 11, 1984.

Some examples of guides, rollers, guide elements, or guide arrangements which may possibly be used in at least one possible embodiment of the present invention may be found in the following U.S. Pat. No. 5,634,297, issued to inventor Ito on Jun. 3, 1997; U.S. Pat. No. 5,461,829, issued to inventors Lehto et al. on Oct. 31, 1995; U.S. Pat. No. 5,349,783, issued to inventors Jasperson et al. on Sep. 27, 1994; U.S. Pat. No. 5,263,280, issued to inventor Dilcher on Nov. 23, 1993; U.S. Pat. No. 5,203,116, issued to inventor Chen on Apr. 20, 1993; U.S. Pat. No. 5,063,710, issued to inventor Schap on Nov. 12, 1991; U.S. Pat. No. 5,039,143, issued to inventor Ramsauer on Aug. 13, 1991; U.S. Pat. No. 5,031,271, issued to inventor Baus on Jul. 16, 1991; U.S. Pat. No. 4,991,257, issued to inventor Eutebach on Feb. 12, 1991; U.S. Pat. No. 4,938,273, issued to inventors Dubbelman et al. on Jul. 3, 1990; U.S. Pat. No. 4,912,807, issued to inventors Futch et al. on Apr. 3, 1990; U.S. Pat. No. 4,924,625, issued to inventor Dilcher on May 15, 1990; U.S. Pat. No. 4,836,263, issued to inventor Ament on Jun. 6, 1989; U.S. Pat. No. 4,802,707, issued to inventor Schlapp on Feb. 7, 1989; U.S. Pat. No. 4,773,465, issued to inventor Hamacher on Sep. 27, 1988; U.S. Pat. No. 4,707,022, issued to inventors Roos et al. on Nov. 17, 1987; U.S. Pat. No. 4,702,514, issued to inventor Perry on Oct. 27, 1987; U.S. Pat. No. 4,680,828, issued to inventors Cook et al. on Jul. 21, 1987; U.S. Pat. No. 4,672,712, issued to inventor Stevenson on Jun. 16, 1987; U.S. Pat. No. 4,668,008, issued to inventor Stinson on May 26, 1987; U.S. Pat. No. 4,577,577, issued to inventor Erikeson on Mar. 25, 1986; U.S. Pat. No. 4,565,031, issued to inventor Sakamoto on Jan. 21, 1986; U.S. Pat. No. 4,503,637, issued to inventor Parente on Mar. 12, 1985; U.S. Pat. No. 4,455,709, issued to inventor Zanini on Jun. 26, 1984; U.S. Pat. No. 4,398,373, issued to inventor Mancuso on Aug. 16, 1983; U.S. Pat. No. 4,358,863, issued to inventor Jacobsen on Nov. 16, 1982; U.S. Pat. No. 4,281,435, issued to inventors Winter et al. on Aug. 4, 1981; U.S. Pat. No. 4,228,560, issued to inventor Baus on Oct. 21, 1980; U.S. Pat. No. 4,183,179, issued to inventors Gutridge et al. on Jan. 15, 1980; U.S. Pat. No. 4,176,497, issued to inventor Nagy on Dec. 4, 1979; U.S. Pat. No. 4,176,496, issued to inventors Rock et al. on Dec. 4, 1979; U.S. Pat. No. 4,064,593, issued to inventor Helmick on Dec. 27, 1977; and U.S. Pat. No. 4,063,388, issued to inventor Little on Dec. 20, 1977.

Some examples of turnouts or turnout switches which may be utilized or incorporated in at least one possible embodiment of the present invention may be found in the following U.S. Pat. No. 5,577,691, issued to inventors Erich et al. on Nov. 26, 1996; U.S. Pat. No. 5,375,797, issued to inventor Willow on Dec. 27, 1994; U.S. Pat. No. 4,970,964, issued to inventors Burg et al. on Nov. 20, 1990; U.S. Pat. No. 4,970,962, issued to inventors Burg et al. on Nov. 20, 1990; U.S. Pat. No. 4,890,804, issued to inventors Teramoto et al. on Jan. 2, 1990; and U.S. Pat. No. 4,005,839, issued to inventor Frank on Feb. 1, 1977.

Some examples of linkages or actuator arms which may be utilized or incorporated in at least one possible embodiment of the present invention may be found in the following U.S. Pat. No. 5,417,013, issued to inventor Tillmann on May 23, 1995; U.S. Pat. No. 5,163,494, issued to inventors MacNeil et al. on Nov. 17, 1992; U.S. Pat. No. 5,149,180, issued to inventors Haab et al. on Sep. 22, 1992; U.S. Pat. No. 5,121,976, issued to inventors Haab et al. on Jun. 16, 1992; U.S. Pat. No. 5,058,238, issued to inventor Lautenschlager on Oct. 22, 1991; U.S. Pat. No. 4,821,375, issued to inventor Kozon on Apr. 18, 1989; U.S. Pat. No. 4,759,099, issued to inventors Morano et al. on Jul. 26, 1988; U.S. Pat. No. 4,669,147, issued to inventor Suchanek on Jun. 2, 1987; U.S. Pat. No. 4,419,787, issued to inventor Lieberman on Dec. 13, 1983; U.S. Pat. No. 4,285,094, issued to inventor Levings, Jr. on Aug. 25, 1981; U.S. Pat. No. 4,184,382, issued to inventor Redman on Jan. 22, 1980; and U.S. Pat. No. 4,080,687, issued to inventor Jentsch on Mar. 28, 1978.

Some examples of door closers which may be utilized or incorporated in at least one possible embodiment of the present invention may be found in the following U.S. Pat. No. 5,832,561, issued to inventor Bienek on Nov. 10, 1998; U.S. Pat. No. 5,802,670, issued to inventor Bienek on Sep. 8, 1998; U.S. Pat. No. 5,770,934, issued to inventor Theile on Jun. 23, 1998; U.S. Pat. No. 5,651,216, issued to inventor Tillmann on Jul. 29, 1997; U.S. Pat. No. 5,428,278, issued to inventors Bollengier et al. on Jun. 27, 1995; U.S. Pat. No. 5,417,013, issued to inventor Tillmann on May 23, 1995; U.S. Pat. No. 5,251,400, issued to inventor Schultze on Oct. 12, 1993; U.S. Pat. No. 4,669,147, issued to inventor Suchanek on Jun. 2, 1987; U.S. Pat. No. 4,501,090, issued to inventors Yoshida et al. on Feb. 26, 1985; U.S. Pat. No. 4,419,787, issued to inventor Lieberman on Dec. 13, 1983; and U.S. Pat. No. 4,285,094, issued to inventor Levings, Jr. on Aug. 25, 1981.

Some further examples of door closers which may be utilized or incorporated in a possible embodiment of the present invention may be found in the advertising brochure, entitled “Des Programm”, for the company DORMA GmbH +Co. KG, Postfach 4009, D-58247 Ennepetal, Federal Republic of Germany, which advertising brochure bears the following identifying information: WN 051307, December 1996, Programm, D, 10, STB, February 1997, Atelier G. Heinz, Velbert, which advertising brochure describes, for example, on page 25, the door closer or drive system named the “DORMA ED 200”.

Some examples of sensors, sensor systems, pressure sensing apparatuses, and/or strain gauges which may be utilized or incorporated in at least one possible embodiment of the present invention may be found in the following U.S. Pat. No. 5,770,934, issued to inventor Theile on Jun. 23, 1998; U.S. Pat. No. 5,625,266, issued to inventor Stark on Apr. 29, 1997; U.S. Pat. No. 5,428,278, issued to inventors Bollengier et al. on Jun. 27, 1995; U.S. Pat. No. 5,303,593, issued to inventor Kremidas on Apr. 19, 1994; U.S. Pat. No. 5,287,757, issued to inventors Polaert et al. on Feb. 22, 1994; U.S. Pat. No. 5,251,400, issued to inventor Schultze on Oct. 12, 1993; U.S. Pat. No. 5,241,308, issued to inventor Young on Aug. 31, 1993; U.S. Pat. No. 5,199,519, issued to inventors Polaert et al. on Apr. 6, 1993; U.S. Pat. No. 5,191,798, issued to inventors Tabata et al. on Mar. 9, 1993; U.S. Pat. No. 5,186,060, issued to inventor Marlier on Feb. 16, 1993; U.S. Pat. No. 5,142,152, issued to inventor Boiucaner on Aug. 25, 1992; U.S. Pat. No. 4,815,046, issued to inventor Dorr on Mar. 21, 1989; U.S. Pat. No. 4,779,240, issued to inventor Dorr on Oct. 18, 1988; U.S. Pat. No. 4,501,090, issued to inventors Yoshida et aI; on Feb. 26, 1985; and U.S. Pat. No. 4,430,846, issued to inventors Presley et al. on Feb. 14, 1984.

Some examples of devices or transmissions which may be utilized or incorporated in at least one possible embodiment of the present invention may be found in the following U.S. Pat. No. 4,763,385, issued to inventors Furch et al. on Aug. 16, 1988, and U.S. Pat. No. 4,744,125, issued to inventors Scheck et al. on May 17, 1988.

Some examples of structures which may be utilized or incorporable in at least one possible embodiment of the present invention may be found in U.S. Pat. No. 6,058,656, issued in May 2000, to Bischof, et al.; U.S. Pat. No. 1,931,796, issued in October 1933, to Hoffman; U.S. Pat. No. 2,807,058, issued in September 1957, to Morgan; U.S. Pat. No. 3,071,825, issued in January 1963, to Ferris; U.S. Pat. No. 4,559,740, issued in December 1985, to Tuchiya et al.; U.S. Pat. No. 4,723,374, issued in February 1988, to Peterson et al.; U.S. Pat. No. 6,073,673, issued in June 2000, to Janutta; U.S. Pat. No. 328,342, issued in October 1885, to Robinson; U.S. Pat. No. 2,135,280, issued in November 1938, to Erickson; U.S. Pat. No. 2,178,271, issued in October 1939, to Soss; U.S. Pat. No. 3,881,221, issued in May 1975, to Schmidt; U.S. Pat. No. 4,995,144, issued in February 1991, to Gately; U.S. Pat. No. 5,410,779, issued in May 1995, to Esman et al.; U.S. Pat. No. 5,537,766, issued in July 1996, to Nickens; U.S. Pat. No. 6,082,053 issued in July 2000, to Bischof, et al.; U.S. Pat. No. 3,683,100, issued in August 1972, to Deal et al.; U.S. Pat. No. 3,748,793, issued in July 1973, to Tompkins et al.; U.S. Pat. No. 4,833,840, issued in May 1989, to Kalischewski et al.; U.S. Pat. No. 5,090,171, issued in February 1992, to Kano et al.; U.S. Pat. No. 5,193,319, issued in March 1993, to Claassen et al.; U.S. Pat. No. 5,406,761, issued in April 1995, to Hobbiebrunken et al.; U.S. Pat. No. 5,471,791, issued in December 1995, to Keller; U.S. Pat. No. 5,577,348, issued in November 1996, to Keller; U.S. Pat. No. 5,804,931, issued in September 1998, to Schack; U.S. Pat. No. 4,621,552, issued in November 1986, to Lopez; U.S. Pat. No. 4,683,789, issued in August 1987, to Lopez; U.S. Pat. No. 5,770,934, issued in June 1998, to Theile; U.S. Pat. No. 4,338,553, issued in July 1982, to Scott; U.S. Pat. No. 4,386,398, issued in May 1983, to Matsuoka et al.; U.S. Pat. No. 4,638,433, issued in January 1987, to Schindler; U.S. Pat. No. 4,855,653, issued in August 1989, to Lemirande; U.S. Pat. No. 5,278,480, issued in January 1994, to Murray; U.S. Pat. No. 5,625,266, issued in April 1997, to Stark; U.S. Pat. No. 4,449,078, issued in May 1984, to Ogishi et al.; U.S. Pat. No. 4,563,625, issued in January 1986, to Kornbrekke et al.; U.S. Pat. No. 5,127,190, issued in July 1992, to Hein et al.; U.S. Pat. No. 5,234,512, issued in August 1993, to Inoue et al.; U.S. Pat. No. 5,495,918, issued in March 1996, to Peruggi et al.; U.S. Pat. No. 5,509,504, issued in April 1996, to McHugh et al.; U.S. Pat. No. 4,449,078, issued in May 1984, to Ogishi et al.; U.S. Pat. No. 4,563,625, issued in January 1986, to Kornbrekke et al.; U.S. Pat. No. 5,127,190, issued in July 1992, to Hein et al.; U.S. Pat. No. 5,234,512, issued in August 1993, to Inoue et al.; U.S. Pat. No. 5,495,918, issued in March 1996, to Peruggi et al.; U.S. Pat. No. 5,509,504, issued in April 1996, to McHugh et al.; U.S. Pat. No. 6,098,342, issued in August 2000 to Bischof; U.S. Pat. No. 4,651,469, issued in March 1987, to Ngian et al.; U.S. Pat. No. 4,775,127, issued in October 1988, to Nakamura; and U.S. Pat. No. 4,854,078, issued in August 1989, to DePrima; European Patent Nos.: 413881, issued in February 1991; 0679788, issued in November 1995; 0528032, issued in February 1993; 0471230, issued in February 1992; 0574851, issued in December 1993; 0468361, issued in January 1992; 0548505, issued in June 1993; 0590227, issued in April 1994; 0192157, issued in August 1986; 0264350, issued in April 1988; 0457861, issued in November 1991; 0192157, issued in August 1986; 0264350, issued in April 1988; and 0457861, issued in November 1991; Federal Republic of Germany Patent Nos.: 3148464, issued in December 1982; 4041925, issued in March 1992; 3147273, issued in July 1983; 4015870, issued in November 1991; 9214915, issued in April 1993; 4424660, issued in September 1995; 6603588, issued in August 1967; 3921158, issued in January 1991; 4206272, issued in September 1993; 9307326, issued in September 1993; 4214998, issued in November 1993; 3940762, issued in June 1991; 4134396, issued in May 1992; 4207705, issued in April 1993; 3940762, issued in June 1991; 4134396, issued in May 1992; 4207705, issued in April 1993; and 4041925, issued in March 1992; French Patent No.: 1496751, issued in October 1967; Great Britain Patent Nos.: 0570540, issued in July 1945; and 1076949, issued in July 1967; and International Publication Nos.: 9318444, issued in Septmer 1993; and 9318444, issued in September 1993, WO.

Some examples of snap-in elements may possibly be found in U.S. Pat. Nos. 6,021,986; 6,015,126; 5,951,223; D409,623; 5,775,482; 5,702,133; 5,667,271; and 5,593,263.

The invention as described hereinabove in the context of the preferred embodiments is not to be taken as limited to all of the provided details thereof, since modifications and variations thereof may be made without departing from the spirit and scope of the invention.

AT LEAST PARTIAL NOMENCLATURE

| | |
|---|---|
| 1 | Housing |
| 2 | Truck |
| 3 | Roller |
| 4 | Drive unit |
| 5 | Transom profile |
| 6 | Closing profile |
| 7 | Longitudinal leg |
| 8 | Transverse leg |
| 9 | Transverse leg |
| 10 | Cavity |
| 11 | Support leg |
| 12 | Adapter profile |
| 13 | Slot |
| 14 | Interior of housing |
| 15 | Mounting groove |
| 16 | Mounting groove |
| 17 | Chamber |
| 18 | Fin |
| 19 | Opening |
| 20 | Projection |
| 21 | Square-head bolt |
| 22 | Mounting bracket |
| 23 | Bolt channel |
| 24 | Channel |
| 25 | Horizontal leg segment |
| 26 | Vertical leg segment |
| 27 | Extension |
| 28 | Cross strut |
| 29 | Rib |
| 30 | Running profile |
| 31 | Underside |
| 32 | Web |
| 33 | Web |
| 34 | Accessory channel |
| 35 | Rib |
| 36 | Cover profile |
| 37 | Cover |
| 38 | Locking arm |
| 39 | Extension |
| 40 | Leg |
| 41 | U-shaped profile |
| 42 | Transverse partition |
| 43 | Leg |
| 44 | Edge |
| 45 | Projection |
| 46 | Transverse web |
| 47 | Transverse web |

What is claimed is:

1. A sliding panel system having panels sliding along at least one slide rail arrangement comprising an automatic drive system having horizontally movable elements in a housing for automatic drive systems of horizontally movable elements, whereby the housing (1) is used in particular to hold mechanical, electrical and electronic components such as running devices (2, 3), suspension devices for movable elements, drive units (4) comprising power transmission means, coupling, motor and displacement sensing devices, auxiliary drives, open-loop/closed-loop control systems, power supply, sensors etc., characterized by the fact that the housing (1) comprises a C-shaped transom profile (5) which can be closed by means of a closing profile (6) to realize a housing interior (14) and on which a support leg (11) is realized in one piece, thereby forming a cavity (10).

2. The system as claimed in claim 1, characterized by the fact that the transom profile (5) has a longitudinal leg (7), to which transverse legs (8, 9) are connected at right angles on the upper and lower ends, whereby the support leg (11) is realized between the longitudinal leg (7) and the lower transverse leg (9).

3. The system as claimed in claim 2, characterized by the fact that the support leg (11) is stepped and has a horizontal leg segment (25) and a vertical leg segment (26).

4. The system as claimed in claim 3, characterized by the fact that the support leg (11) forms a closable channel (24).

5. The system as claimed in claim 4, characterized by the fact that shaped onto the support leg (11) is a vertical extension (27) that ends in a cross strut (28) that is extended toward both sides.

6. The system as claimed in claim 5, characterized by the fact that undercut mounting grooves (15, 16) are realized on the extension (27), the support leg (11), the transverse legs (8, 9) and/or the longitudinal leg (7).

7. The system as claimed in claim 6, characterized by the fact that in the upper transverse leg (8), there are two mounting grooves (15) which are at some distance from each other.

8. The system as claimed in claim 7, characterized by the fact that the closing profile (6) is located on the upper transverse profile (8).

9. The system as claimed in claim 7, characterized by the fact that on the upper transverse leg (8), a chamber (17) is realized for the locking attachment of an adapter profile (12), whereby the closing profile (6) is located on the adapter profile (12).

10. The system as claimed in claim 9, characterized by the fact that a running profile (30) can be positively fastened on the bottom transverse leg (9).

11. The system as claimed in claim 10, characterized by the fact that on the underside lower transverse leg (9), between webs (32, 33), there is an accessory channel (34), in which a mounting groove is realized.

12. The system as claimed in claim 11, characterized by the fact that the accessory channel (34) can be closed positively in an interlocking manner by a cover profile (36), whereby the cover profile (36) consists of a cover (37) and two elastically deflectable locking arms (38) which project at right angles.

13. The system as claimed in claim 12, characterized by the fact that the web (32) has an extension (39), on which a U-shaped profile (41) can be located, which profile can be fastened to the lower transverse leg (9).

14. The system as claimed in claim 13, characterized by the fact that the U-shaped profile (41) consists of a transverse partition (42) and two legs (40, 43) that project from it at right angles, whereby the legs (40, 43) each have inwardly bent edges (44) and the leg (43) has an outside projection (45).

15. The system as claimed in claim 14, characterized by the fact that bolt channels (23) are formed between the longitudinal leg (7) and each of the transverse legs (8, 9).
